(19) United States
(12) Patent Application Publication
(10) Pub. No.: US 2022/0103891 A1
(43) Pub. Date: Mar. 31, 2022

(54) LIVE BROADCAST INTERACTION METHOD AND APPARATUS, LIVE BROADCAST SYSTEM AND ELECTRONIC DEVICE

(71) Applicant: GUANGZHOU HUYA INFORMATION TECHNOLOGY CO., LTD., Guangdong (CN)

(72) Inventors: Zihao Xu, Guangdong (CN); Hao WU, Guangdong (CN)

(21) Appl. No.: 17/598,733

(22) PCT Filed: Mar. 27, 2020
(86) PCT No.: PCT/CN2020/081627

§ 371 Date: Sep. 27, 2021

(30) Foreign Application Priority Data
Mar. 29, 2019 (CN) 201910251306.7
Mar. 29, 2019 (CN) 201910252787.3

(51) Int. Cl. H04N 21/431; H04N 21/2187; G06V 20/40; G06V 40/20; G06V 10/82; H04N 21/4788

(52) U.S. Cl. CPC H04N 21/4316; H04N 21/2187; H04N 21/4788; G06V 40/20; G06V 10/82; G06V 20/40

(57) ABSTRACT

Provided are a live broadcast interaction method and apparatus, a live broadcast system and an electronic device. The method comprises: when it is detected from an anchor video frame collected by a video collection apparatus in real time that an anchor initiates an anchor interaction action, detecting an action posture and an action type of the anchor interaction action, wherein the anchor interaction action comprises a target prop wearing action and/or a target limb action; and then, generating, according to the action posture and the action type of the anchor interaction action, an interaction video stream of a virtual image corresponding to the anchor, and sending the interaction video stream of the virtual image to a live broadcast receiving terminal by means of a live broadcast server and playing same.

### CROSS-REFERENCE TO RELATED APPLICATIONS

The present application claims priority to Chinese Patent Application No. 2019102513067, entitled “Live Broadcast Interaction Method and Apparatus, Live Broadcast System, and Electronic device”, and filed with Chinese patent office on Mar. 29, 2019, and Chinese Patent Application No. 2019102527873, entitled “Virtual Image Control Method and Apparatus, and Electronic Device”, and filed with Chinese patent office on Mar. 29, 2019, the entire contents of which are incorporated herein by reference.

### TECHNICAL FIELD

The present application relates to the technical field of Internet, and particularly to a live broadcast interaction method and apparatus, a live broadcast system and an electronic device.

### BACKGROUND ART

To enrich interaction between an anchor and an audience, in a network live broadcast process, in some implementations, a virtual image may be presented on a live broadcast interface, such that the anchor interacts with the audience by means of the virtual image. However, in this solution, the virtual image only demonstrates a certain interaction action simply, and is difficult to be associated with an action of the anchor, which results in a poor actual interaction effect.

### SUMMARY

The present application provides an electronic device including one or more storage media and one or more processors in communication with the storage media. The one or more storage media store machine executable instructions executable by the processor. When the electronic device runs, the processor executes the machine executable instructions to perform a live broadcast interaction method.

The present application provides a live broadcast interaction method applicable to a live broadcast providing terminal, the method including steps of:

when it is detected, from an anchor video frame collected by a video collection apparatus in real time, that an anchor initiates an anchor interaction action, detecting an action posture and an action type of the anchor interaction action,

wherein the anchor interaction action includes a target prop wearing action and/or a target limb action; and

generating, according to the action posture and the action type of the anchor interaction action, an interaction video stream of a virtual image corresponding to the anchor, and sending the interaction video stream of the virtual image to a live broadcast receiving terminal by means of a live broadcast server and playing the same.

In some possible implementations, the step of detecting an action posture and an action type of the anchor interaction action includes:

when it is detected that the anchor wears a target prop, detecting a prop attribute and a reference point position vector of the target prop, and searching for the action type of the target limb action according to the prop attribute; and

predicting the action posture of the anchor interaction action, according to the reference point position vector, by using an inverse kinematic algorithm.

In some possible implementations, the step of detecting an action posture and an action type of the anchor interaction action includes:

when it is detected that the anchor initiates the target limb action, detecting a reference point position vector of the target limb action, and recognizing the action type of the target limb action using an interaction action recognition model; and

predicting the action posture of the anchor interaction action, according to the reference point position vector, using the inverse kinematic algorithm.

In some possible implementations, the step of predicting the action posture of the anchor interaction action according to the reference point position vector using an inverse kinematic algorithm includes:

calculating, according to the reference point position vector, a height of a central point of an interaction limb of the anchor and a posture rotation matrix of the interaction limb of the anchor relative to the video collection apparatus;

calculating a position vector of each limb joint of the interaction limb of the anchor according to the posture rotation matrix, the reference point position vector and the height of the central point, the position vector including a component of the interaction limb of the anchor in each reference axis direction; and

obtaining the action posture of the anchor interaction action according to the calculated position vector of each limb joint.

In some possible implementations, a preset interaction content library is stored in the live broadcast providing terminal in advance, the preset interaction content library includes virtual image interaction content corresponding to each action type, and the virtual image interaction content includes one of conversation interaction content, special effect interaction content and limb interaction content or combination of more of them;

the step of generating according to the action posture and the action type of the anchor interaction action an interaction video stream of the virtual image includes:

acquiring virtual image interaction content corresponding to the action type from the preset interaction content library; and

generating the interaction video stream of the virtual image according to the action posture and the virtual image interaction content.

In some possible implementations, the step of generating the interaction video stream of the virtual image according to the action posture and the virtual image interaction content includes:

controlling, according to displacement coordinate(s) of each target joint point associated with the action posture, each target joint point of the virtual image to move along the corresponding displacement coordinate(s), and controlling the virtual image to execute a corresponding interaction action according to the virtual image interaction content, so as to generate the corresponding interaction video stream.

In some possible implementations, the step of detecting, when it is detected from an anchor video frame collected by a video collection apparatus in real time that an anchor initiates an anchor interaction action, an action posture and an action type of the anchor interaction action includes:

inputting the anchor video frame collected by the video collection apparatus in real time into the pre-trained interaction action recognition model, and recognizing whether the anchor video frame contains the target limb action;

obtaining, when it is detected that the anchor initiates the target limb action, the action type of the target limb action and the reference point position vector of the target limb action; and

predicting the action posture of the anchor interaction action, according to the reference point position vector, using the inverse kinematic algorithm.

In some possible implementations, the interaction action recognition model includes an input layer, at least one convolutional extraction layer, a fully connected layer, and a classification layer, wherein each convolutional extraction layer includes a first point convolutional layer, a deep convolutional layer, and a second point convolutional layer arranged in sequence, an activation function layer and a pooling layer are provided behind each convolutional layer in the convolutional extraction layer, the fully connected layer is located behind the last pooling layer, and the classification layer is located behind the fully connected layer.

In some possible implementations, the interaction action recognition model further includes a plurality of residual network layers, and each residual network layer is configured to connect in series output parts of any two adjacent layers of the interaction action recognition model with an input part of a layer behind the two adjacent layers.

In some possible implementations, the method further includes a step of training the interaction action recognition model in advance, and the step specifically includes:

establishing a neural network model;

pre-training the neural network model using a public data set to obtain a pre-trained neural network model; and

iteratively training the pre-trained neural network model using a collected data set to obtain the interaction action recognition model, the collected data set including a training sample image set marked with actual targets of different anchor interaction actions, and the actual target being an actual image region of the anchor interaction action in a training sample image.

In some possible implementations, the step of iteratively training the pre-trained neural network model using a collected data set to obtain the interaction action recognition model includes:

inputting each training sample image in the training sample image set into an input layer of the pre-trained neural network model for pre-processing, so as to obtain a pre-processed image;

extracting, for each convolutional extraction layer of the pre-trained neural network model, a multi-dimensional feature image of the pre-processed image through the first point convolutional layer, the deep convolutional layer and the second point convolutional layer of the convolutional extraction layer respectively, inputting the extracted multi-dimensional feature image into the connected activation function layer for nonlinear mapping, then inputting the multi-dimensional feature image after nonlinear mapping into the connected pooling layer for pooling, and inputting a pooled feature image obtained by the pooling into the next convolutional layer for feature extraction;

inputting the pooled feature image output by the last pooling layer into the fully connected layer to obtain a fully connected feature output value;

inputting the fully connected feature output value into the classification layer for prediction target classification, so as to obtain a prediction target of each training sample image;

calculating a loss function value between the actual target and the prediction target of each training sample image;

performing back propagation training according to the loss function value, and calculating a gradient of a network parameter of the pre-trained neural network model; and

updating the network parameter of the pre-trained neural network model according to the calculated gradient using a stochastic gradient descent method, continuing training until the pre-trained neural network model meets a training termination condition, and outputting the interaction action recognition model obtained by the training.

In some possible implementations, the step of performing back propagation training according to the loss function value and calculating a gradient of a network parameter of the pre-trained neural network model includes:

determining a back propagation path of the back propagation training according to the loss function value; and

selecting a serial connection node corresponding to the back propagation path by means of the residual network layer of the pre-trained neural network model, to perform back propagation training, and calculating the gradient of the network parameter of the pre-trained neural network model when the serial connection node corresponding to the back propagation path is reached.

In some possible implementations, before the step of iteratively training the pre-trained neural network model using a collected data set to obtain the interaction action recognition model, the method further includes:

adjusting the image parameter of each training sample image in the training sample image set, so as to perform sample expansion on the training sample image set.

In some possible implementations, the step of inputting the anchor video frame collected by the video collection apparatus in real time into the pre-trained interaction action recognition model and recognizing whether the anchor video frame contains the anchor interaction action includes:

inputting the anchor video frame into the interaction action recognition model to obtain a recognition result image, the recognition result image including at least one target box, and the target box being a geometric box for marking the anchor interaction action in the recognition result image; and

determining whether the anchor video frame contains an anchor interaction action according to the recognition result image of the anchor video frame.

In some possible implementations, the step of inputting the anchor video frame into the interaction action recognition model to obtain a recognition result image includes:

segmenting the anchor video frame into a plurality of grids by means of the interaction action recognition model;

generating, for each grid, a plurality of geometric prediction boxes with different attribute parameters in the each grid, each geometric prediction box corresponding to a reference box, and the attribute parameters of each geometric prediction box including a central point coordinate relative to the reference box, a width, a height and a category;

calculating a confidence score of each geometric prediction box, and removing, according to the calculation result, the geometric prediction box with the confidence score lower than a preset score threshold; and

ranking the rest geometric boxes in the grid in a descending order of the confidence scores, and determining the geometric box with the highest confidence score as the target box according to the ranking result, so as to obtain the recognition result image.

In some possible implementations, the step of calculating a confidence score of each geometric prediction box includes:

Judging, for each geometric prediction box, whether an anchor interaction action exists in the region of each geometric prediction box;

determining, if the anchor interaction action does not exist, that the geometric prediction box has a confidence score of 0;

calculating, if the anchor interaction action exists, a posterior probability that the region of the geometric prediction box belongs to the anchor interaction action, and calculating a detection evaluation function value of the geometric prediction box, the detection evaluation function value being used for representing a ratio of an intersection of the anchor interaction action and the geometric prediction box to a union of the anchor interaction action and the geometric prediction box; and

obtaining the confidence score of the geometric prediction box according to the posterior probability and the detection evaluation function value. The present application is provides a live broadcast interaction apparatus applied to a live broadcast providing terminal, the apparatus including:

a detection module, configured to detect, when it is detected from an anchor video frame collected by a video collection apparatus in real time that an anchor initiates an anchor interaction action, an action posture and an action type of the anchor interaction action, wherein the anchor interaction action includes a target prop wearing action and/or a target limb action; and

a generation module, configured to generate, according to the action posture and the action type of the anchor interaction action, an interaction video stream of a virtual image corresponding to the anchor, and send the interaction video stream of the virtual image to a live broadcast receiving terminal by means of a live broadcast server, for playing.

The present application provides a live broadcast system, including a live broadcast providing terminal, a live broadcast receiving terminal and a live broadcast server communicating with the live broadcast providing terminal and the live broadcast receiving terminal respectively;

the live broadcast providing terminal is configured to detect, when it is detected from an anchor video frame collected by a video collection apparatus in real time that an anchor initiates an anchor interaction action, an action posture and an action type of the anchor interaction action, wherein the anchor interaction action includes a target prop wearing action and/or a target limb action;

the live broadcast server is configured to send the interaction video stream of the virtual image to the live broadcast receiving terminal; and

the live broadcast receiving terminal is configured to play the interaction video stream of the virtual image in a live broadcast interface.

The present application provides a readable storage medium having machine executable instructions stored thereon, and computer programs, when executed by a processor, may perform the steps of the above-mentioned live broadcast interaction method.

In the embodiments of the present application, when it is detected from an anchor video frame collected by a video collection apparatus in real time that an anchor initiates an anchor interaction action, an action posture and an action type of the anchor interaction action are detected, wherein the anchor interaction action comprises a target prop wearing action and/or a target limb action. Then, according to the action posture and the action type of the anchor interaction action, an interaction video stream of a virtual image corresponding to the anchor is generated, and the interaction video stream of the virtual image is sent to a live broadcast receiving terminal by means of a live broadcast server and played. In this way, by means of associating interaction content of a virtual image of an anchor with an action posture and an action type of an anchor interaction action, the interaction effect in a live broadcast process can be improved, manual operations when the anchor initiates virtual image interaction are reduced, and automatic interaction of the virtual image is achieved.

To make the foregoing objectives, features, and advantages of the embodiments of the present application more apparent and lucid, a detailed description is provided in conjunction with embodiments and the accompanying drawings.

### BRIEF DESCRIPTION OF DRAWINGS

To describe the technical solutions in the embodiments of the present application more clearly, the following briefly describes the accompanying drawings required in the embodiments. It should be understood that the following accompanying drawings show merely some embodiments of the present application and therefore should not be considered as limiting the scope, and a person of ordinary skill in the art may still derive other related drawings from these accompanying drawings without creative efforts.

FIG. 1 shows a schematic block diagram of an application scenario of a live broadcast system according to an embodiment of the present application;

FIG. 2 shows a schematic flow chart of a live broadcast interaction method according to the embodiment of the present application;

FIG. 3 shows a schematic flow chart of possible substeps of Step S110;

FIG. 4 shows a schematic diagram of a network structure of a neural network model according to the embodiment of the present application;

FIG. 5 shows a schematic diagram of a training flow of the neural network model according to the embodiment of the present application;

FIG. 6 shows a schematic diagram of a live broadcast interface of a live broadcast providing terminal according to the embodiment of the present application;

FIG. 7 shows a schematic diagram of another live broadcast interface of the live broadcast providing terminal according to the embodiment of the present application; and

FIG. 8 shows a schematic diagram of an exemplary component of the live broadcast providing terminal shown in FIG. 1 according to the embodiment of the present application.

### DETAILED DESCRIPTION

To make the objectives, technical solutions and advantages of the embodiments of the present application clearer, the technical solutions in the embodiments of the present application are clearly and completely described with reference to the accompanying drawings in the embodiments of the present application, and it should be understood that the drawings in the present application are only for illustration and description purposes and are not intended to limit the protection scope of the present application. Further, it should be understood that the schematic drawings are not drawn to scale. The flow charts used in the present application show operations implemented according to some of the embodiments of the present application. It should be understood that the operations of the flow charts may be performed out of order, and that steps without a logical context relationship may be reversed in order or performed concurrently. Furthermore, those skilled in the art, under the guidance of the present application, may add one or more other operations to the flow chart, or may remove one or more operations from the flow chart.

In addition, the described embodiments are merely some but not all of the embodiments of the present application. Generally, the components of the embodiments of the present application described and illustrated in the drawings herein may be arranged and designed in a variety of different configurations. Accordingly, the following detailed description of the embodiments of the present application provided in the drawings is not intended to limit the scope of protection of the present application, but only represents selected embodiments of the present application. All other embodiments obtained by those skilled in the art based on the embodiments of the present application without creative efforts shall fall within the protection scope of the present application.

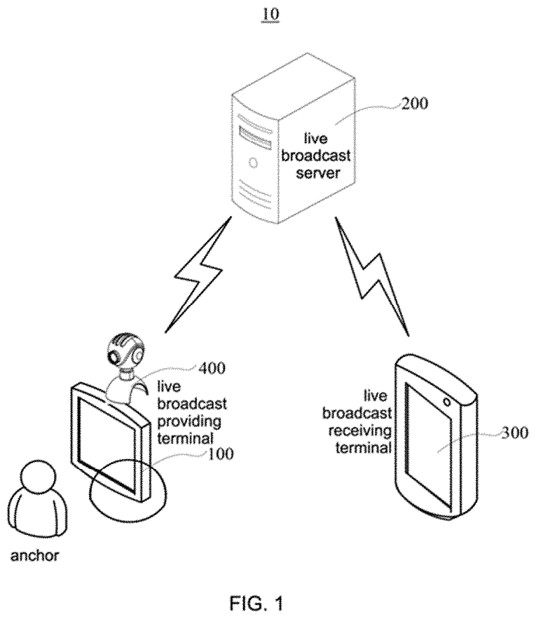

FIG. 1 is a schematic diagram of an application scenario of a live broadcast system 10 according to an embodiment of the present application. For example, the live broadcast system 10 may be a service platform configured for an Internet live broadcast, for example. Referring to FIG. 1, the live broadcast system 10 may include a live broadcast server 200, a live broadcast providing terminal 100, and a live broadcast receiving terminal 300, wherein the live broadcast server 200 communicates with the live broadcast providing terminal 100 and the live broadcast receiving terminal 300 respectively, and configured to provide live broadcast service for the live broadcast providing terminal 100 and the live broadcast receiving terminal 300. For example, the live broadcast providing terminal 100 may send a live broadcast video stream of a live broadcast room to the live broadcast server 200, and an audience may access the live broadcast server 200 by the live broadcast receiving terminal 300 to watch a live broadcast video of the live broadcast room. For another example, the live broadcast server may also send a notification message to the live broadcast receiving terminal 300 of the audience when the broadcast of the live broadcast room that the audience subscribes to starts. The live broadcast video stream may be a video stream currently broadcast live in a live broadcast platform or a complete video stream formed after the live broadcast is completed.

It may be understood that the live broadcast system 10 shown in FIG. 1 is only one possible example, and in other possible embodiments, the live broadcast system 10 may include only a part of the components shown in FIG. 1 or may include other components. For example, in some possible implementations, the live broadcast providing terminal 100 may also be in direct communication with the live broadcast receiving terminal 300, and the live broadcast providing terminal 100 may directly send data of the live broadcast video stream to the live broadcast receiving terminal 300.

In some implementation scenarios, the live broadcast providing terminal 100 and the live broadcast receiving terminal 300 may be used interchangeably. For example, an anchor of the live broadcast providing terminal 100 may use the live broadcast providing terminal 100 to provide live broadcast video service for the audience, or watch live broadcast video(s) provided by other anchor(s) as an audience. For another example, the audience of the live broadcast receiving terminal 300 may also use the live broadcast receiving terminal 300 to watch a live broadcast video provided by a concerned anchor, or provide live broadcast video service as an anchor for other audiences.

In the present embodiment, the live broadcast system 10 may further include a video collection apparatus 400 configured to collect an anchor video frame of the anchor, and the video collection apparatus 400 may be directly installed on or integrated in the live broadcast providing terminal 100, or may be independent of the live broadcast providing terminal 100 and connected to the live broadcast providing terminal 100.

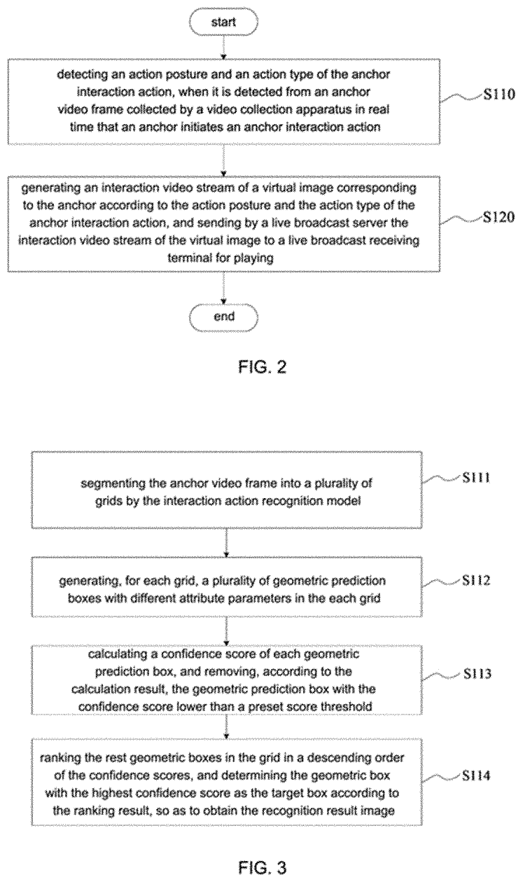

FIG. 2 shows a schematic flow chart of a live broadcast interaction method according to the embodiment of the present application, and the live broadcast interaction method may be executed by the live broadcast providing terminal 100 shown in FIG. 1. It should be understood that in other embodiments, the order of some steps in the live broadcast interaction method according to the present embodiment may be interchanged according to actual needs, or some steps may be omitted or deleted. Detailed steps of the live broadcast interaction method are described as follows.

Step S110: detecting, when it is detected from the anchor video frame collected by the video collection apparatus 400 in real time that the anchor initiates an anchor interaction action, an action posture and an action type of the anchor interaction action.

As a possible implementation, the video collection apparatus 400 may collect the anchor video frame of the anchor according to a preset real-time anchor video frame collection rate. The aforementioned real-time anchor video frame collection rate may be set according to an actual network bandwidth, a processing performance of the live broadcast providing terminal 100, and a network transmission protocol. Generally, a three-dimensional engine may provide different rendering rates of 60 frames/s, 30 frames/s, or the like, and in the present embodiment, the required real-time anchor video frame collection rate may be determined according to objective factors, such as the actual network bandwidth, the processing performance of the live broadcast providing terminal and a target transmission protocol, thus guaranteeing a real-time performance and a smoothness of video streams for subsequently rendering the virtual image.

In the present embodiment, the anchor interaction action may include a target prop wearing action and/or a target limb action.

Taking determination of the action type and the action posture according to a target prop as an example, when it is detected that the anchor wears the target prop in the anchor video frame, a prop attribute and a reference point position vector of the target prop may be detected, the action type of the target limb action is searched for according to the prop attribute, and then, the action posture of the anchor interaction action is predicted according to the reference point position vector using an inverse kinematic (IK) algorithm.

In the above, the target props may be various interaction props which may be identified by the live broadcast platform and used for indicating the action types of the anchor interaction actions, and the attributes of the interaction props may include shape information. In this case, the interaction prop may be designed according to the action type of the specific anchor interaction action. For example, if interaction prop A is used to indicate “a scissor-gesture cute action”, interaction prop A may be designed in a scissor gesture shape. For another example, if interaction prop B is used to indicate “a heart-gesture warm action”, interaction prop B may be designed in a heart gesture shape.

Or, the prop attributes of these interaction props may further include color information; in this case, the color of the interaction prop may be designed according to the action type of the specific anchor interaction action; for example, if interaction prop A is used to indicate “a scissor-gesture cute action”, interaction prop A may be designed to be red, and for another example, if interaction prop A is used to indicate “a heart-gesture warm action”, interaction prop B may be designed to be blue. By the design, the live broadcast providing terminal 100 may quickly identify the action type of the target limb action by identifying the attribute of the interaction prop, without performing recognition using a deep neural network algorithm, thereby greatly reducing a calculation amount and improving an identification speed and identification precision.

In another implementation, when it is detected that the anchor initiates the target limb action from the anchor video frame, a reference point position vector of the target limb action may be detected, and the action type of the target limb action is recognized using a deep neural network model. Then, the action posture of the anchor interaction action is predicted according to the reference point position vector using the inverse kinematic (IK) algorithm.

In other words, in the present embodiment, the anchor video frame collected by the video collection apparatus in real time may be input into a pre-trained interaction action recognition model to recognize whether the anchor video frame includes a target limb action; when it is detected that the anchor initiates the target limb action, the action type of the target limb action and the reference point position vector of the target limb action are obtained; and the action posture of the anchor interaction action is predicted according to the reference point position vector using the inverse kinematic algorithm.

Optionally, the types of the target limb actions may include, but are not limited to, limb actions commonly used in the live broadcast, such as standing up, sitting down, circling, standing upside down, body shaking, waving, a scissor gesture, first making, a heart gesture, hand lifting, clapping, palm opening, palm closing, a thumbs-up gesture, a pistol posture, a V-gesture, an OK-gesture, or the like.

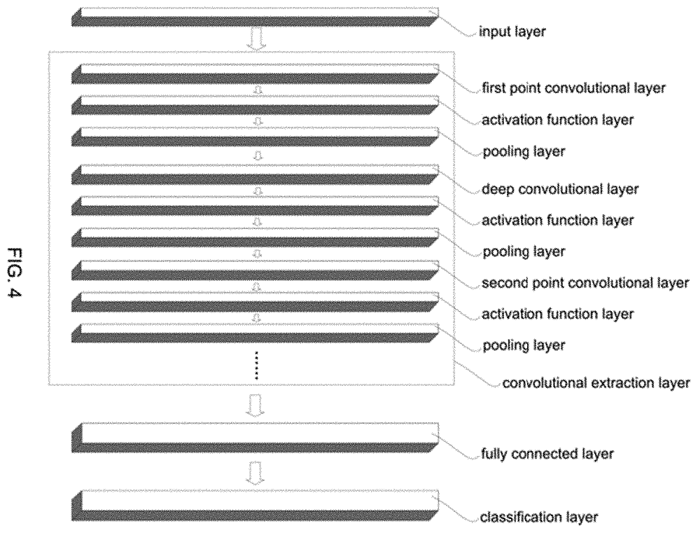

In this example, the live broadcast providing terminal 100 may input the anchor video frame into the interaction action recognition model in step S110, so as to obtain a recognition result image, and determine the action type of the target limb action included in the anchor video frame according to the recognition result image. In the above, the above-mentioned recognition result image includes at least one target box, and the target box is a geometric box for marking the action type of the target limb action in the recognition result image. Referring to FIG. 3, in this example, step S110 may include the following substeps:

Substep S111: segmenting the anchor video frame into a plurality of grids by means of the interaction action recognition model;

Substep S112: generating, for each grid, a plurality of geometric prediction boxes with different attribute parameters in the each grid, each geometric prediction box corresponding to a reference box, and the attribute parameters of each geometric prediction box including a central point coordinate relative to the reference box, a width, a height and a category, thereby adapting to a diversity of live broadcast scenarios; and

Substep S113: calculating a confidence score of each geometric prediction box, and removing, according to the calculation result, the geometric prediction box with the confidence score lower than a preset score threshold.

For example, it may be judged, for each geometric predictionbox, whether an anchor interaction action exists in the region of each geometric prediction box,

wherein if the target limb action does not exist, the geometric prediction box is determined to have a confidence score of 0;

if the target limb action exists, a posterior probability that the region of the geometric prediction box belongs to the target limb action is calculated, and a detection evaluation function value of the geometric prediction box is calculated, the detection evaluation function value being used for representing a ratio of an intersection of the target limb action and the geometric prediction box to a union of the target limb action and the geometric prediction box.

Finally, the confidence score of the geometric prediction box may be obtained according to a product of the posterior probability and the detection evaluation function value.

On the basis, a preset score threshold may be preset, wherein if a confidence score of a geometric prediction box is lower than the preset score threshold, a target in the geometric prediction box is impossible to be a prediction target of the live broadcast interaction action; and if a confidence score of the geometric prediction box is greater than the preset score threshold, the target in the geometric prediction box is likely to be the prediction target of the live broadcast interaction action.

Thus, the geometric prediction boxes with confidence scores lower than the preset score threshold may be removed selectively, such that a large number of geometric prediction boxes which are unlikely to have the target of the live broadcast interaction action are removed at one time, and only the geometric prediction boxes which are likely to have the target of the live broadcast interaction action are processed subsequently, thereby greatly reducing a subsequent calculation amount, and further increasing the identification speed.

Substep S114: ranking the rest geometric boxes in the grid in a descending order of the confidence scores, and determining the geometric box with the highest confidence score as the target box according to the ranking result, so as to obtain the recognition result image.

Thus, if a target box marked with the target limb action exists in the recognition result image of a live broadcast image, the anchor video frame is determined to contain the target limb action, and the interaction action type of the target limb action may be determined.

When it is detected from the anchor video frame that the anchor initiates a target limb action, the live broadcast providing terminal 100 may also predict the action posture of the anchor interaction action according to the reference point position vector of the target limb action or the reference point position vector of the target prop, using the inverse kinematic algorithm, so as to provide a data basis for subsequently realizing overall action synchronization between the virtual image and the anchor.

For example, the live broadcast providing terminal 100 may calculate, according to the reference point position vector, a height of a central point of an interaction limb of the anchor and a posture rotation matrix of the interaction limb of the anchor relative to the video collection apparatus 400. Next, the live broadcast providing terminal calculates a position vector of each limb joint of the interaction limb of the anchor according to the posture rotation matrix, the reference point position vector and the height of the central point, the position vector including a component of the interaction limb of the anchor in each reference axis direction. Finally, the live broadcast providing terminal obtains the action posture of the anchor interaction action according to the calculated position vector of each limb joint.

In the above, the reference axis direction may be configured in advance, and taking a two-dimensional space as an example, the reference axis direction may include an X-axis direction and a Y-axis direction which are perpendicular to each other; taking a three-dimensional space as an example, the reference axis direction may include an X-axis direction, a Y-axis direction, and a Z-axis direction which are perpendicular to one another.

The posture rotation matrix of the interaction limb of the anchor relative to the video collection apparatus 400 mainly refers to a position and a posture of the interaction limb relative to the video collection apparatus 400 in the two-dimensional space or three-dimensional space. Taking the three-dimensional space as an example, the position may be described using a position matrix, and the posture may be recorded as a posture matrix formed by cosine values of included angles between the three coordinate axes of a coordinate system.

In the present embodiment, the interaction action recognition model may be obtained based on training of a neural network model, and as a possible implementation, referring to FIG. 4, the above-mentioned interaction action recognition model may include an input layer, at least one convolutional extraction layer, a fully connected layer, and a classification layer. Each convolutional extraction layer includes a plurality of sequentially arranged convolutional layers, such as a first point convolutional layer, a deep convolutional layer and a second point convolutional layer, or the like, arranged in this order. An activation function layer and a pooling layer are provided behind each convolutional layer in the convolutional extraction layer, the fully connected layer is located behind the last pooling layer, and the classification layer is located behind the fully connected layer. The training process for the interaction action recognition model will be described later, and is not described herein.

The process of training the foregoing neural network model to obtain the interaction action recognition model is explained in detail below.

First, a neural network model is established. Optionally, the neural network model may be, but is not limited to, a Yolov2 network model. A unit with a small calculation amount is adopted in a yolov2 network to adapt to the live broadcast providing terminal, for example, an electronic device with a weaker calculating capability, such as a mobile phone, a user terminal, or the like, and specifically, a PointwiseDepthwise+Pointwise convolutional structure or common three-convolutional-layer structure may be adopted; a gradient descent method is adopted in the training process to perform back propagation training, and a residual network is adopted in the training process to change a direction of a gradient during training.

Next, the neural network model is pre-trained using a public data set to obtain a pre-trained neural network model. In the above, the public data set may be a COCO data set, the COCO data set is a large image data set and is specially designed for object detection, segmentation, human body key point detection, semantic segmentation and subtitle generation, and mainly captured from a complex daily scenario, and a position of a detection target in an image is calibrated by accurate segmentation, such that the neural network model has capabilities of primary target detection, recognition of a context relationship between the targets and two-dimensional accurate location of the targets.

Then, the pre-trained neural network model is iteratively trained using a collected data set to obtain the interaction action recognition model.

In the above, the collected data set includes a training sample image set marked with actual targets of different anchor interaction actions, and the actual target is an actual image region of the anchor interaction action in a training sample image. For example, the collected data set may include, but is not limited to, anchor images corresponding to different anchor interaction actions collected in a live broadcast process, or images uploaded by the anchor after performing different anchor interaction actions. The anchor interaction action may include a common interaction action in the live broadcast process, for example, a scissor-gesture cute action, a heart-gesture warm action, or the like, which is not specifically limited in the present embodiment.

Optionally, in order to enable the interaction action recognition model to recognize the anchor interaction action under different environments, in the present embodiment, the image parameter of each training sample image in the training sample image set may be adjusted, so as to perform sample expansion on the training sample image set. For example, to accommodate environments where the anchor is located at different distances from the video collection apparatus 400 in the live broadcast process, a plurality of equal-scale cropping operations with different scales may be performed on an initially collected data set to obtain an equal-scale cropped data set related to the initially collected data set. For another example, in order to adapt to live broadcast environments where the live broadcast is performed under different light intensities, exposure adjustment may be performed on the initially collected data set to obtain an exposure adjustment data set related to the initially collected data set. For another example, to adapt to live broadcast environments where the live broadcast is performed in different noise environments, different levels of noise may be added to the initially collected data set to obtain a noise data set related to the initially collected data set. As such, the subsequent recognition capability of the interaction action recognition model in different live broadcast scenarios may be effectively improved by performing sample expansion on the training sample image set.

Since the whole recognition process of the interaction action is performed at the live broadcast providing terminal 100, in order to effectively reduce the calculation amount of the live broadcast providing terminal 100 and improve the recognition speed, by means of the above-mentioned network structure design, each convolutional extraction layer has a separable convolutional structure, that is, is composed of a cascade structure of the first point convolutional layer, the deep convolutional layer and the second point convolutional layer, and compared with the common three-convolutional-layer structure, such a cascade structure has smaller calculation amount and network parameter number.

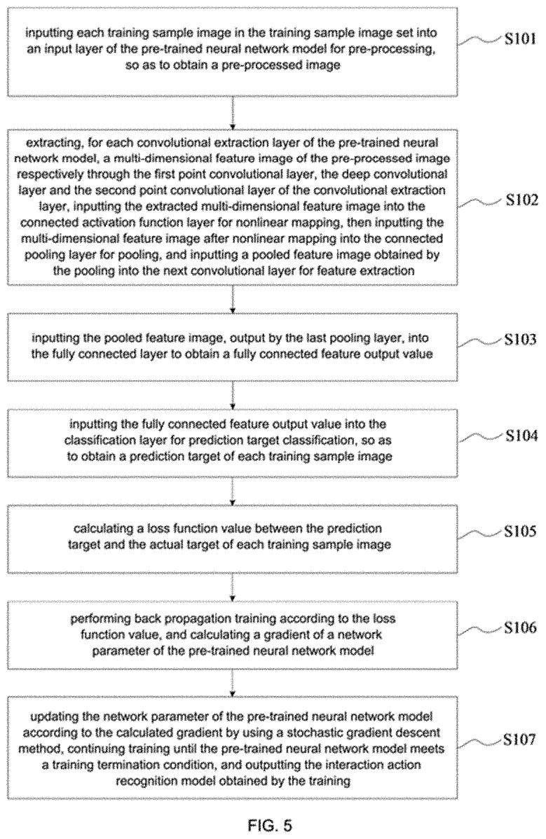

The foregoing process of iteratively training the pre-trained neural network model using the collected data set is described for illustration below in conjunction with the neural network model shown in FIG. 4; referring to FIG. 5, step S101, step S102, step S103, step S104, step S105, step S106, and step S107 are further included before step S110, and the step S101, step S102, step S103, step S104, step S105, step S106, and step S107 are described below respectively.

Step S101: inputting each training sample image in the training sample image set into an input layer of the pre-trained neural network model for pre-processing, so as to obtain a pre-processed image. In detail, since the stochastic gradient descent method is subsequently required to be used for training, each input training sample image is required to be standardized.

For example, each training sample image may be averaged; in detail, each dimension of each training sample image may be centralized to 0, all the training sample images are summed and then averaged to obtain a mean sample, and then, the mean sample is subtracted from all the training sample images to obtain the pre-processed image.

As another example, a data amplitude of each training sample image may also be normalized to a same range, such as range [−1, 1] for each feature, thereby obtaining the pre-processed image.

For another example, PCA dimension reduction may be performed on each training sample image to cancel correlation of each dimension, features are independent from each other, and then, the amplitude of each training sample image on each feature axis is normalized to obtain the pre-processed image.

Step S102: for each convolutional extraction layer, extracting a multi-dimensional feature image of the pre-processed image through the first point convolutional layer, the deep convolutional layer and the second point convolutional layer of the convolutional extraction layer respectively, inputting the extracted multi-dimensional feature image into the connected activation function layer for nonlinear mapping, then inputting the multi-dimensional feature image after nonlinear mapping into the connected pooling layer for pooling, and inputting a pooled feature image obtained by pooling into the next convolutional layer for feature extraction.

The first point convolutional layer, the deep convolutional layer and the second point convolutional layer have a function of extracting features of input image data, and each internally include a plurality of convolution kernels, and each element forming the convolution kernel corresponds to a weight coefficient and a deviation value, i.e., a neuron. The multi-dimensional feature image of each pre-processed image has one property called a local association property, and a pixel point of one pre-processed image has a largest influence on pixel points around the pre-processed image, and has little relationship with a pixel point far away from the pixel point. As such, each neuron is only required to be locally connected with the previous layer; equivalently, each neuron scans a small region, and then, a plurality of neurons (weights of these neurons are shared) are combined, and equivalently, a global feature image is scanned, such that a one-dimensional feature image is formed, and the multi-dimensional feature image is obtained by extracting multi-dimensional features of the pre-processed image.

On the basis, the multi-dimensional feature image obtained by extraction is input into the connected activation function layer for nonlinear mapping, so as to assist in expressing complex features in the multi-dimensional feature image. Optionally, the activation function layer may be, but is not limited to, a rectified linear unit (ReLU), a Sigmoid function, a hyperbolic tangent function, or the like.

Then, the multi-dimensional feature image subjected to the nonlinear mapping is input into the connected pooling layer for pooling; that is, the multi-dimensional feature image subjected to the nonlinear mapping is transferred to the pooling layer for feature selection and information filtering, and the pooling layer may contain a preset pooling function, such that a result of a single point of the multi-dimensional feature image subjected to the nonlinear mapping is replaced by feature image statistics of an adjacent region thereof. Next, the pooled feature image obtained by the pooling is input into the next convolutional layer for continuous feature extraction.

Step S103: inputting the pooled feature image output by the last pooling layer into the fully connected layer to obtain a fully connected feature output value. In detail, all neurons in the fully connected layer are connected with weights, and after all the previous convolutional layers (i.e., the first point convolutional layer, the deep convolutional layer and the second point convolutional layer) extract feature images enough to recognize a to-be-processed image, the feature image is required to be classified through the fully connected layer to obtain the fully connected feature output value.

Step S104: inputting the fully connected feature output value into the classification layer for prediction target classification, so as to obtain a prediction target of each training sample image.

Step S105: calculating a loss function value between the prediction target and the actual target of each training sample image.

Step S106: performing back propagation training according to the loss function value, and calculating a gradient of a network parameter of the pre-trained neural network model.

Optionally, in the present embodiment, the interaction action recognition model may further include a plurality of residual network layers (not shown), and each residual network layer is configured to connect in series output parts of any two adjacent layers of the interaction action recognition model with an input part of a layer behind the two adjacent layers. Thus, different back propagation paths may be selected when the gradient is used for back propagation training, thus enhancing a training effect.

In detail, after the loss function value is determined, the back propagation path of back propagation training may be determined according to the loss function value, a serial connection node corresponding to the back propagation path is then selected by means of the residual network layer of the pre-trained neural network model to perform back propagation training, and the gradient of the network parameter of the pre-trained neural network model is calculated when the serial connection node corresponding to the back propagation path is reached.

Step S107: updating the network parameter of the pre-trained neural network model according to the calculated gradient using a stochastic gradient descent method, and continuing training until the pre-trained neural network model meets a training termination condition, and outputting the interaction action recognition model obtained by the training.

In the above, the above-mentioned training termination condition may include at least one of the following conditions:

1) the number of iterative training (iterations) reaches a set number; 2) the loss function value is lower than a set threshold; and 3) the loss function value does not decrease any more.

In the above, in condition 1), in order to save an operation amount, a maximum value of the number of the iterations may be set, and if the number of the iterations reaches the set number, the iteration of this iteration cycle may be stopped, and the finally obtained pre-trained neural network model is used as the interaction action recognition model. In condition 2), if the loss function value is lower than the set threshold, which indicates that the current interaction action recognition model may substantially satisfy the condition, the iteration may be stopped. In condition 3), the loss function value no longer decreases, which indicates that the optimal interaction action recognition model is formed, and the iteration may be stopped.

It should be noted that the above-mentioned iteration stop conditions may be used in combination or alternatively; for example, the iteration may be stopped when the loss function value no longer decreases, or the iteration may be stopped when the number of the iterations reaches the set number, or the iteration may be stopped when the loss function value no longer decreases. Or, the iteration may also be stopped when the loss function value is below the set threshold and the loss function value no longer decreases.

Furthermore, in an actual implementation process, training termination conditions may not be limited to the above-mentioned example, and those skilled in the art may design a training termination condition different from the above-mentioned example according to actual requirements.

Step S120: generating, according to the action posture and the action type of the anchor interaction action, an interaction video stream of the virtual image corresponding to the anchor, and sending, through the live broadcast server 200, the interaction video stream of the virtual image to the live broadcast receiving terminal 300 for playing.

In the above, the virtual image may be a virtual character image which has a consistent appearance, posture, action mode, or the like, with the anchor, and may be displayed in a live broadcast interface in the form of a two-dimensional virtual image, a three-dimensional virtual image, a VR virtual image, an AR virtual image, or the like, such that live broadcast interaction may be performed with the audience.

In the present embodiment, a preset interaction content library may be stored in the live broadcast providing terminal 100 in advance, the preset interaction content library includes virtual image interaction contents corresponding to individual action types, and the virtual image interaction contents include one of conversation interaction content, special effect interaction content and limb interaction content, or combinations of more of them. Optionally, the live broadcast providing terminal 100 may locally configure the preset interaction content library in advance, and the live broadcast providing terminal 100 may also download the preset interaction content library from the live broadcast server 200, which is not limited in the present embodiment.

Optionally, the conversation interaction content may include interaction information, such as a subtitle picture, a subtitle special effect, or the like; the special effect interaction content may include image information, such as a static special effect picture, a dynamic special effect picture, or the like; and the limb interaction content may include image information, such as a facial expression (such as happiness, anger, excitement, distress, sadness, or the like) special effect picture, or the like.

Thus, after determination of the action posture and the action type of the anchor interaction action, the virtual image interaction content corresponding to the action type may be obtained from the preset interaction content library, and then, the interaction video stream of the virtual image is generated according to the action posture and the virtual image interaction content. In detail, according to displacement coordinate(s) of each target joint point associated with the action posture, each target joint point of the virtual image may be controlled to move along the corresponding displacement coordinate(s), and the virtual image may be controlled to execute a corresponding interaction action according to the virtual image interaction content, so as to generate the corresponding interaction video stream. As such, the interaction action of the virtual image may be similar to the action of the anchor, thereby improving an interaction degree of the anchor and the audience.

As a possible implementation, in the above-mentioned process, the interaction video stream of the virtual image may be generated using a graphic image drawing or rendering method, or the like. Optionally, a 2D graphic image or a 3D graphic image may be drawn based on an OpenGL graphic drawing engine, a Unity 3D rendering engine, or the like, so as to generate the interaction video stream of the virtual image, such that the interaction video stream with an interaction effect of the virtual image is displayed. OpenGL defines a specialized graphic program interface with a cross-programming language and cross-platform programming interface specification, which is independent of hardware, such that the 2D or 3D graphic image may be conveniently drawn. By means of the OpenGL and/or Unity 3D rendering engines, or the like, not only a 2D effect, such as a 2D sticker or special effect may be drawn, but also a 3D special effect, a particle special effect, or the like, may be drawn.

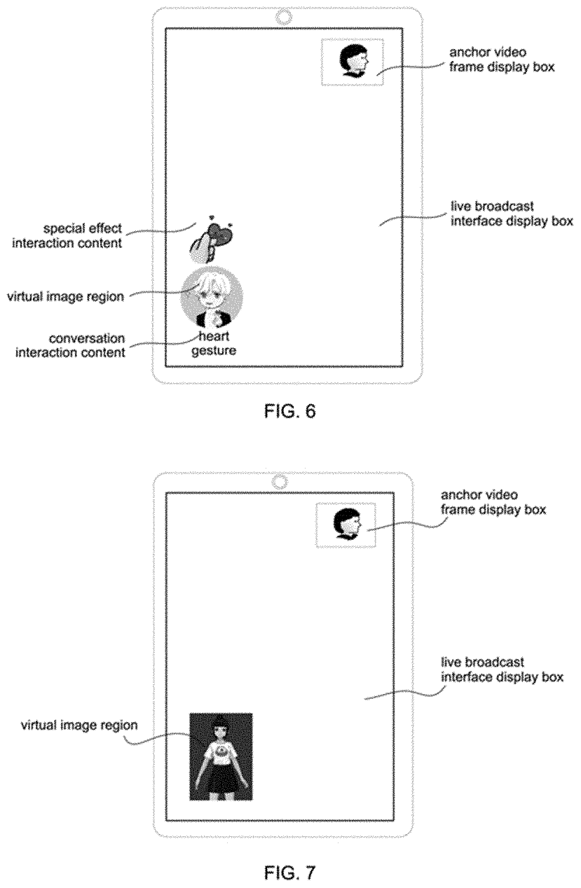

By way of example only, referring to FIG. 6 which shows an exemplary view of a live broadcast interface of the live broadcast providing terminal 100, and in the live broadcast interface, a live broadcast interface display box, an anchor video frame display box, and a virtual image region may be included. In the above, the live broadcast interface display box is used for displaying a video stream which is currently broadcast live in a live broadcast platform or a complete video stream formed after the live broadcast is completed, the anchor video frame display box is used for displaying the anchor video frame which is collected by the video collection apparatus 400 in real time, and the virtual image region is used for displaying the virtual image of the anchor.

When the anchor initiates an anchor interaction action, the anchor video frame display box may display the anchor interaction action initiated by the anchor, and meanwhile, the action posture and the action type of the anchor interaction action may be detected, and then, the virtual image interaction content corresponding to the action type is obtained, and the virtual image in the virtual image region is controlled to execute the corresponding interaction action. For example, if the identified anchor interaction action is a heart-gesture warm action, the virtual image is controlled to execute the corresponding heart-gesture warm action, the special effects of the conversation interaction content “heart gesture” and the special effect interaction content “heart gesture” are displayed, the interaction video stream of the virtual image is then generated, and the interaction video stream is sent to the live broadcast receiving terminal 300 by the live broadcast server 200 for playing.

Thus, in the present embodiment, by means of associating the interaction content of the virtual image of the anchor with the action posture and the action type of the anchor interaction action, the interaction effect in the live broadcast process may be improved, manual operations when the anchor initiates the virtual image interaction are reduced, and automatic interaction of the virtual image is achieved.

In some other implementations, after it is detected in the anchor video frame collected by the video collection apparatus in real time that the anchor initiates an anchor interaction action, the virtual image interaction content may be directly determined according to the anchor interaction action, and the interaction video stream of the virtual image may be sent to the live broadcast receiving terminal 300.

For example, the anchor video frame collected by the video collection apparatus in real time may be first input into the pre-trained interaction action recognition model, so as to recognize whether the anchor video frame contains the anchor interaction action. Then, when the anchor interaction action is recognized in a preset number of anchor video frames, the preset virtual image interaction content corresponding to the anchor interaction action is obtained. Then, the virtual image in the live broadcast interface of the live broadcast providing terminal is controlled according to the virtual image interaction content to execute the corresponding interaction action, so as to generate the interaction video stream of the virtual image, and send by the live broadcast server the interaction video stream to the live broadcast receiving terminal for playing. In the above, in order to avoid misidentification of the anchor interaction action, when the anchor interaction action is recognized in a preset number of anchor video frames, the preset virtual image interaction content corresponding to the anchor interaction action may be obtained.

A preset interaction content library is stored in the live broadcast providing terminal 100 in advance, the preset interaction content library includes pre-configured virtual image interaction contents corresponding to individual anchor interaction actions, and the virtual image interaction contents may include one of conversation interaction content, special effect interaction content and limb interaction content, or combinations of more of them. Optionally, the live broadcast providing terminal 100 may locally configure the preset interaction content library, and may also download the preset interaction content library from the live broadcast server 200, which is not limited in the present embodiment.

By way of example only, referring to FIG. 7 which shows an exemplary view of a live broadcast interface of the live broadcast providing terminal 100, and the live broadcast interface may include a live broadcast interface display box, an anchor video frame display box, and a virtual image region. In the above, the live broadcast interface display box is used for displaying a video stream which is currently broadcast live in a live broadcast platform or a complete video stream formed after the live broadcast is completed, the anchor video frame display box is used for displaying the anchor video frame which is collected by the video collection apparatus 400 in real time, and the virtual image region is used for displaying the virtual image of the anchor.

When the anchor initiates an anchor interaction action, the anchor video frame display box may display the anchor interaction action initiated by the anchor, and meanwhile, the virtual image interaction content corresponding to the anchor interaction action may be obtained, and then, the virtual image in the virtual image region is controlled to execute the corresponding interaction action. For example, if the identified anchor interaction action is a heart-gesture warm action, the virtual image may be controlled to execute the corresponding heart-gesture warm action, and the special effects of the conversation interaction content “heart gesture” and “love you” are displayed. Thus, the interaction video stream of the virtual image may be generated, and the interaction video stream may be sent by the live broadcast server 200 to the live broadcast receiving terminal 300 for playing.

Thus, in the present embodiment, by means of associating the interaction content of the virtual image of the anchor with the anchor interaction action, the interaction effect in the live broadcast process may be improved, manual operations when the anchor initiates the virtual image interaction are reduced, and automatic interaction of the virtual image is achieved.

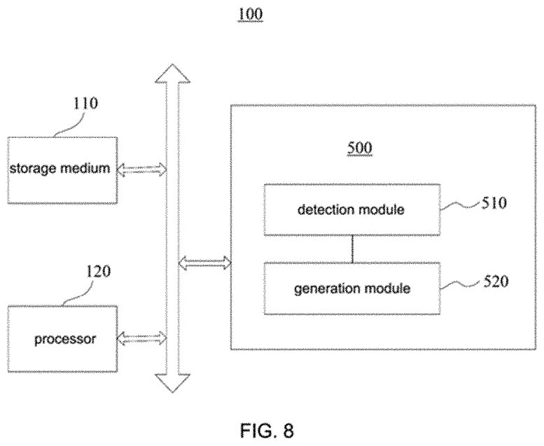

FIG. 8 shows a schematic diagram of an exemplary component of the live broadcast providing terminal 100 shown in FIG. 1 according to the embodiment of the present application, and the live broadcast providing terminal 100 may include a storage medium 110, a processor 120, and a live broadcast interaction apparatus 500. In the present embodiment, the storage medium 110 and the processor 120 are both located in the live broadcast providing terminal 100 and are disposed separately. However, it should be understood that the storage medium 110 may be independent of the live broadcast providing terminal 100 and may be accessed by the processor 120 through a bus interface. Alternatively, the storage medium 110 may be integrated into the processor 120, for example, may be a cache and/or a general purpose register.

The live broadcast interaction apparatus 500 may be understood as the above-mentioned live broadcast providing terminal 100, or the processor 120 of the live broadcast providing terminal 100, or may be understood as a software functional module which is independent of the above-mentioned live broadcast providing terminal 100 or the processor 120 and implements the above-mentioned live broadcast interaction method under the control of the live broadcast providing terminal 100. As shown in FIG. 7, the live broadcast interaction apparatus 500 may include a detection module 510 and a generation module 520, and functions of the functional modules of the live broadcast interaction apparatus 500 are described in detail below.

The detection module 510 is configured to detect, when it is detected from an anchor video frame collected by a video collection apparatus 400 in real time that an anchor initiates an anchor interaction action, an action posture and an action type of the anchor interaction action, wherein the anchor interaction action includes a target prop wearing action and/or a target limb action. It may be understood that the detection module 510 may be configured to perform the above-mentioned step S110, and for the detailed implementation of the detection module 510, reference may be made to the above-mentioned content related to step S110.

The generation module 520 is configured to generate, according to the action posture and the action type of the anchor interaction action, an interaction video stream of a virtual image corresponding to the anchor, and send by means of a live broadcast server 200 the interaction video stream of the virtual image to a live broadcast receiving terminal 300 for playing. It may be understood that the generation module 520 may be configured to perform the above-mentioned step S120, and for the detailed implementation of the generation module 520, reference may be made to the above-mentioned content related to step S120.

Further, embodiments of the present application further provide a computer readable storage medium having machine executable instructions stored thereon, the machine executable instructions, when executed, implementing the live broadcast interaction method according to the above-mentioned embodiments.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

### INDUSTRIAL APPLICABILITY

In the embodiments of the present application, when it is detected from an anchor video frame collected by a video collection apparatus in real time that an anchor initiates an anchor interaction action, an action posture and an action type of the anchor interaction action are detected, wherein the anchor interaction action comprises a target prop wearing action and/or a target limb action. Then, according to the action posture and the action type of the anchor interaction action, an interaction video stream of a virtual image corresponding to the anchor is generated, and the interaction video stream of the virtual image is sent by a live broadcast server to a live broadcast receiving terminal for playing. Thus, by means of associating interaction content of a virtual image of an anchor with an action posture and an action type of an anchor interaction action, the interaction effect in a live broadcast process can be improved, manual operations when the anchor initiates virtual image interaction are reduced, and automatic interaction of the virtual image is achieved.

1. A live broadcast interaction method applicable to a live broadcast providing terminal, the method comprising:
detecting an action posture and an action type of the anchor interaction action, when it is detected from an anchor video frame collected by a video collection apparatus in real time that an anchor initiates an anchor interaction action,
wherein the anchor interaction action comprises a target prop wearing action and/or a target limb action; and
generating, according to the action posture and the action type of the anchor interaction action, an interaction video stream of a virtual image corresponding to the anchor, and sending, by a live broadcast server, the interaction video stream of the virtual image to a live broadcast receiving terminal for playing.

2. The live broadcast interaction method according to claim 1, wherein the step of detecting an action posture and an action type of the anchor interaction action comprises:
detecting, when it is detected that the anchor wears a target prop, a prop attribute and a reference point position vector of the target prop, and searching for the action type of the target limb action according to the prop attribute; and
predicting the action posture of the anchor interaction action according to the reference point position vector by using the inverse kinematic algorithm.

3. The live broadcast interaction method according to claim 1, wherein the step of detecting an action posture and an action type of the anchor interaction action comprises:
detecting a reference point position vector of the target limb action when it is detected that the anchor initiates the target limb action, and recognizing the action type of the target limb action using a deep neural network model; and
predicting the action posture of the anchor interaction action according to the reference point position vector by using an inverse kinematic algorithm.

4. The live broadcast interaction method according to claim, 3, wherein the step of predicting the action posture of the anchor interaction action according to the reference point position vector by using an inverse kinematic algorithm comprises:
calculating, according to the reference point position vector, a height of a central point of an interaction limb of the anchor and a posture rotation matrix of the interaction limb of the anchor relative to the video collection apparatus;
calculating a position vector of each limb joint of the interaction limb of the anchor according to the posture rotation matrix, the reference point position vector and the height of the central point, the position vector comprising a component of the interaction limb of the anchor in each reference axis direction; and
obtaining the action posture of the anchor interaction action according to the calculated position vector of each limb joint.

5. The live broadcast interaction method according to claim 4, wherein a preset interaction content library is stored in the live broadcast providing terminal in advance, the preset interaction content library comprises virtual image interaction contents corresponding to individual action types, and the virtual image interaction contents comprise one of conversation interaction content, special effect interaction content and limb interaction content or combination of more of them; and
the step of generating according to the action posture and the action type of the anchor interaction action an interaction video stream of the virtual image comprises:
acquiring virtual image interaction content corresponding to the action type from the preset interaction content library; and
generating the interaction video stream of the virtual image according to the action posture and the virtual image interaction content.

6. The live broadcast interaction method according to claim 5, wherein the step of generating the interaction video stream of the virtual image according to the action posture and the virtual image interaction content comprises:
controlling, according to at least one displacement coordinate of each target joint point associated with the action posture, each target joint point of the virtual image to move along the corresponding at least one displacement coordinate, and controlling, according to the virtual image interaction content, the virtual image to execute a corresponding interaction action, so as to generate the corresponding interaction video stream.

7. The live broadcast interaction method according to claim 1, wherein the step of detecting an action posture and an action type of the anchor interaction action when it is detected from an anchor video frame collected by a video collection apparatus in real time that an anchor initiates an anchor interaction action comprises:
inputting the anchor video frame collected by the video collection apparatus in real time into the pre-trained interaction action recognition model, and recognizing whether the anchor video frame contains the target limb action;
obtaining the action type of the target limb action and the reference point position vector of the target limb action, when it is detected that the anchor initiates the target limb action; and
predicting the action posture of the anchor interaction action according to the reference point position vector by using the inverse kinematic algorithm.

8. The live broadcast interaction method according to claim 7, wherein the interaction action recognition model comprises an input layer, at least one convolutional extraction layer, a fully connected layer, and a classification layer, each convolutional extraction layer comprises a first point convolutional layer, a deep convolutional layer, and a second point convolutional layer arranged in sequence, an activation function layer and a pooling layer are provided behind each convolutional layer in the convolutional extraction layer, the fully connected layer is located behind the last pooling layer, and the classification layer is located behind the fully connected layer.

9. The live broadcast interaction method according to claim 8, wherein the interaction action recognition model further comprises a plurality of residual network layers, and each residual network layer is configured to connect in series output parts of any two adjacent layers of the interaction action recognition model with an input part of a layer behind the two adjacent layers.

10. The live broadcast interaction method according to claim 9, wherein the method further comprises a step of training the interaction action recognition model in advance, and the step comprises:
establishing a neural network model;
pre-training the neural network model using a public data set to obtain a pre-trained neural network model; and
iteratively training the pre-trained neural network model using a collected data set to obtain the interaction action recognition model, the collected data set comprising a training sample image set marked with actual targets of different anchor interaction actions, and the actual target being an actual image region of the anchor interaction action in a training sample image.

11. The live broadcast interaction method according to claim 10, wherein the step of iteratively training the pre-trained neural network model using a collected data set to obtain the interaction action recognition model comprises:
inputting each training sample image in the training sample image set into an input layer of the pre-trained neural network model for pre-processing, so as to obtain a pre-processed image;
extracting, for each convolutional extraction layer of the pre-trained neural network model, a multi-dimensional feature image of the pre-processed image respectively through the first point convolutional layer, the deep convolutional layer and the second point convolutional layer of the convolutional extraction layer, inputting the extracted multi-dimensional feature image into the connected activation function layer for nonlinear mapping, then inputting the multi-dimensional feature image after nonlinear mapping into the connected pooling layer for pooling, and inputting a pooled feature image obtained by the pooling into the next convolutional layer for feature extraction;
inputting the pooled feature image output by last pooling layer into the fully connected layer to obtain a fully connected feature output value;
inputting the fully connected feature output value into the classification layer for prediction target classification, so as to obtain a prediction target of each training sample image;
calculating a loss function value between the actual target and the prediction target of each training sample image;
performing back propagation training according to the loss function value, and calculating a gradient of a network parameter of the pre-trained neural network model; and
updating the network parameter of the pre-trained neural network model according to the calculated gradient by using a stochastic gradient descent method, and continuing training until the pre-trained neural network model meets a training termination condition, and outputting the interaction action recognition model obtained by the training.

12. The live broadcast interaction method according to claim 11, wherein the step of performing back propagation training according to the loss function value and calculating a gradient of a network parameter of the pre-trained neural network model comprises:
determining a back propagation path of the back propagation training according to the loss function value; and
selecting a serial connection node corresponding to the back propagation path by the residual network layer of the pre-trained neural network model to perform back propagation training, and calculating the gradient of the network parameter of the pre-trained neural network model when the serial connection node corresponding to the back propagation path is reached.

13. The live broadcast interaction method according to claim 10, wherein before the step of iteratively training the pre-trained neural network model using a collected data set to obtain the interaction action recognition model, the method further comprises:
adjusting the image parameter of each training sample image in the training sample image set, so as to perform sample expansion on the training sample image set.

14. The live broadcast interaction method according to claim 7, wherein the step of inputting the anchor video frame collected by the video collection apparatus in real time into the pre-trained interaction action recognition model and recognizing whether the anchor video frame contains the anchor interaction action comprises:
inputting the anchor video frame into the interaction action recognition model to obtain a recognition result image, the recognition result image comprising at least one target box, and the target box being a geometric box for marking the anchor interaction action in the recognition result image; and
determining whether the anchor video frame contains an anchor interaction action according to the recognition result image of the anchor video frame.

15. The live broadcast interaction method according to claim 14, wherein the step of inputting the anchor video frame into the interaction action recognition model to obtain a recognition result image comprises:
segmenting the anchor video frame into a plurality of grids by the interaction action recognition model;
generating, for each grid, a plurality of geometric prediction boxes with different attribute parameters in the each grid, each geometric prediction box corresponding to a reference box, and the attribute parameters of each geometric prediction box comprising a central point coordinate relative to the reference box, a width, a height and a category;
calculating a confidence score of each geometric prediction box, and removing, according to the calculation result, the geometric prediction box with the confidence score lower than a preset score threshold; and
ranking the rest geometric boxes in the grid in a descending order of the confidence scores, and determining the geometric box with the highest confidence score as the target box according to the ranking result, so as to obtain the recognition result image.

16. The live broadcast interaction method according to claim 15, wherein the step of calculating a confidence score of each geometric prediction box comprises:
judging, for each geometric prediction box, whether an anchor interaction action exists in a region of the each geometric prediction box;
determining, if the anchor interaction action does not exist, that the geometric prediction box has a confidence score of 0; and
calculating, if the anchor interaction action exists, a posterior probability that the region of the geometric prediction box belongs to the anchor interaction action, and calculating a detection evaluation function value of the geometric prediction box, the detection evaluation function value being used for representing a ratio of an intersection of the anchor interaction action and the geometric prediction box to a union of the anchor interaction action and the geometric prediction box; and
obtaining the confidence score of the geometric prediction box according to the posterior probability and the detection evaluation function value.

17. A live broadcast interaction apparatus applicable to a live broadcast providing terminal, the apparatus comprising:
a detection module configured to detect, when it is detected from an anchor video frame collected by a video collection apparatus in real time that an anchor initiates an anchor interaction action, an action posture and an action type of the anchor interaction action, wherein the anchor interaction action comprises a target prop wearing action and/or a target limb action; and
a generation module configured to generate, according to the action posture and the action type of the anchor interaction action, an interaction video stream of a virtual image corresponding to the anchor, and send by a live broadcast server the interaction video stream of the virtual image to a live broadcast receiving terminal for playing.

18. A live broadcast system, comprising a live broadcast providing terminal, a live broadcast receiving terminal and a live broadcast server communicating with the live broadcast providing terminal and the live broadcast receiving terminal respectively;
wherein the live broadcast providing terminal is configured to detect, when it is detected from an anchor video frame collected by a video collection apparatus in real time that an anchor initiates an anchor interaction action, an action posture and an action type of the anchor interaction action, generate, according to the action posture and the action type of the anchor interaction action, an interaction video stream of a virtual image corresponding to the anchor, and send the interaction video stream of the virtual image to a live broadcast server, wherein the anchor interaction action comprises a target prop wearing action and/or a target limb action;
the live broadcast server is configured to send the interaction video stream of the virtual image to the live broadcast receiving terminal; and
the live broadcast receiving terminal is configured to play the interaction video stream of the virtual image in a live broadcast interface.

19. (canceled)

20. (canceled)

21. The live broadcast interaction method according to claim 2, wherein the step of predicting the action posture of the anchor interaction action according to the reference point position vector by using an inverse kinematic algorithm comprises:
calculating, according to the reference point position vector, a height of a central point of an interaction limb of the anchor and a posture rotation matrix of the interaction limb of the anchor relative to the video collection apparatus;
calculating a position vector of each limb joint of the interaction limb of the anchor according to the posture rotation matrix, the reference point position vector and the height of the central point, the position vector comprising a component of the interaction limb of the anchor in each reference axis direction; and
obtaining the action posture of the anchor interaction action according to the calculated position vector of each limb joint.

22. The live broadcast interaction method according to claim 1, wherein a preset interaction content library is stored in the live broadcast providing terminal in advance, the preset interaction content library comprises virtual image interaction contents corresponding to individual action types, and the virtual image interaction contents comprise one of conversation interaction content, special effect interaction content and limb interaction content or combination of more of them; and
the step of generating according to the action posture and the action type of the anchor interaction action an interaction video stream of the virtual image comprises:
acquiring virtual image interaction content corresponding to the action type from the preset interaction content library; and
generating the interaction video stream of the virtual image according to the action posture and the virtual image interaction content.
